(19) United States
(12) Patent Application Publication
(10) Pub. No.: US 2014/0289658 A1
(43) Pub. Date: Sep. 25, 2014

(54) METHODS, SYSTEMS AND APPARATUSES FOR MANAGING THE PRESENTATION OF INFORMATION

(71) Applicants: Daniel Gelernter, Woodbridge, CT (US); David Gelernter, Woodbridge, CT (US); Eric Freeman, Bainbridge Island, WA (US); Peter Prosol, New York, NY (US)

(72) Inventors: Daniel Gelernter, Woodbridge, CT (US); David Gelernter, Woodbridge, CT (US); Eric Freeman, Bainbridge Island, WA (US); Peter Prosol, New York, NY (US)

(21) Appl. No.: 13/847,221

(22) Filed: Mar. 19, 2013

(51) Int. Cl. G06F 3/0484

(52) U.S. Cl. CPC G06F 3/04842
USPC 715/765

(57) ABSTRACT

Index entries may be generated for incoming items of information and may include timestamps associated with an identification of the relevant item. Timestamps may be reassigned in response to user commands or according to preconfigured instructions. Items may be output, visually or aurally, according to their associated timestamps. Items may be clustered together according to user commands or preconfigured instructions. Timestamp reassignment and clustering may be configured according to information relevant to corresponding items or information which is not directly relevant to the items themselves.

### BACKGROUND

In today's electronic age, information is now more plentiful than ever. However, the widespread adoption of the internet and electronic communications has resulted in an overwhelming amount of information being thrust upon information consumers. Increasingly, consumers are unable to effectively digest the sheer volume of information they are bombarded with on a daily basis.

Thus, there exists a need for a way to manage the presentation of information such that a consumer is able to efficiently receive and comprehend flows of information.

### SUMMARY

In general, in one aspect, the invention features an apparatus for managing the presentation of information, including a processor, a communication transceiver configured to receive a plurality of items, a display, a user input configured to receive a timestamp reassignment command and storage storing instructions performable by the processor. The instructions may be performable by the processor to generate, for each received item, an index entry in an index including an identification of the item and an initial timestamp associated with the identification of the item, cause the display to display a plurality of received items in graphical form and ordered according to timestamps in the index which are associated with identifications of the items and reassign, in response to a receipt of a timestamp reassignment command associated with a particular item, a timestamp associated with an identification of the particular item in the index to a reassigned timestamp according to the timestamp reassignment command.

Implementations of the invention may include one or more of the following features. The index may be stored by the storage. The initial timestamp may be determined according to attributes of the associated item. A timestamp reassignment command may be configured to cause the processor to determine the reassigned timestamp based on timestamps associated with identifications of other items in the index. The timestamp reassignment command may be configured to cause the processor to select a reassigned timestamp that is between timestamps associated with identifications of other items in the index. The timestamp reassignment command may be configured to cause the processor to increment the timestamp associated with the identification of the particular item in the index by an amount of time specified in the timestamp reassignment command to obtain the reassigned timestamp. The timestamp reassignment command may include at least one reassignment criteria and the timestamp reassignment command may be configured to cause the processor to analyze information unrelated to the particular item for satisfaction of the reassignment criteria to determine the reassigned timestamp. The information unrelated to the particular item may include at least one of a geographical location identified by GPS receiver in communication with the apparatus, a weather forecast and a current time. The timestamp reassignment command may include at least one reassignment criteria and the processor may be configured to assign a null timestamp to the particular item and cause the display to cease displaying the particular item in graphical form until the processor determines that the reassignment criteria have been met. The timestamp reassignment command may be a recurring timestamp reassignment command and may be configured to cause the processor to reassign the timestamp of the particular item a plurality of times in according to a parameters specified by the recurring timestamp reassignment command. The recurring timestamp reassignment command may be configured to cause the processor to check for updates to content associated with the particular item each time the timestamp is reassigned in accordance therewith.

In general, in another aspect, the invention features an apparatus for managing the presentation of information, including a processor, a communication transceiver configured to receive a plurality of items, an audio output, a user input configured to receive a timestamp reassignment command and storage storing instructions performable by the processor. The instructions may be performable by the processor to generate, for each received item, an index entry in an index including an identification of the item and an initial timestamp associated with the identification of the item, cause the audio output to sequentially output audio corresponding to a plurality of received items, the audio ordered sequentially according to timestamps in the index which are associated with identifications of the items and reassign, in response to a receipt of a timestamp reassignment command associated with a particular item, a timestamp associated with an identification of the particular item in the index to a reassigned timestamp according to the timestamp reassignment command.

In general, in yet another aspect, the invention features a method for managing the presentation of information, including the steps of receiving a plurality of items, generating, for each received item, an index entry in an index including an identification of the item and an initial timestamp associated with the identification of the item, displaying a plurality of received items in graphical form ordered according to timestamps in the index which are associated with identifications of the items, receiving a timestamp reassignment command associated with a particular item and reassigning, in response to receipt of the timestamp reassignment command associated with the particular item, a timestamp associated with an identification of the particular item in the index to a reassigned timestamp according to the timestamp reassignment command.

In general, in still another aspect the invention features an apparatus for managing the presentation of information, including a processor, a communication transceiver configured to receive items, a display and storage storing instructions performable by the processor to cause the display to display a queue of information based on the received items perform clustering processing to group selected items from the plurality of received items into a clustered queue entry based on clustering criteria and cause the display to display the clustered queue entry in graphical form as an entry in the queue of information.

Implementations of the invention may also include one or more of the following additional features. The instructions may also be performable by the processor to cause the display to display a selected item which is not grouped by the clustering processing in graphical form as an entry in the queue of information. The clustering criteria may include a source from which items are received. The clustering processing may also be performed by the processor based on cluster division criteria such that groups of items determined based on the clustering criteria are divided into subgroups based on the cluster division criteria and the subgroups are the basis for the clustered queue entries. The apparatus may further include a user input configured to receive a clustering aggressiveness command, wherein the extent of the clustering processing may be controlled according to the received clustering aggressiveness command. The clustering processing may be applied to each received item according to attributes of each received item such that clustering processing applied to one received item may be different than clustering processing applied to another received item based on differences in attributes of the one received item and the another received item.

In general, in another aspect the invention features a method for managing the presentation of information, including the steps of receiving a plurality of items, displaying a queue of information based on the received items, performing clustering processing to group selected items from the plurality of received items into a clustered queue entry based on clustering criteria and displaying the clustered queue entry in graphical form as an entry in the queue of information. The method may also include displaying a selected item which is not grouped by the clustering processing in graphical form as an entry in the queue of information.

### BRIEF DESCRIPTION OF THE DRAWINGS

The above mentioned and other aspects, features and advantages can be more readily understood from the following detailed description with reference to the accompanying drawings, wherein:

FIG. 1 is a notional block diagram of a client according to an exemplary embodiment of the present invention;

FIG. 2 is a notional block diagram of a server according to another exemplary embodiment of the present invention;

FIG. 3 is a notional view of a list according to another exemplary embodiment of the present invention;

FIG. 4 is a notional view of a display screen and queue according to another exemplary embodiment of the present invention;

FIGS. 5a and 5b are notional views of a list according to another exemplary embodiment of the present invention;

FIG. 6 is a notional view of a display screen and an expanded timestamp reassignment command window according to another exemplary embodiment of the present invention;

FIGS. 7a, 7b and 7c are notional views of item queues according to other exemplary embodiments of the present invention;

FIG. 8 is a notional view of an index according to another exemplary embodiment of the present invention; and

FIG. 9 is a notional view of a display screen and a list according to another exemplary embodiment of the present invention.

### DETAILED DESCRIPTION

Systems, methodologies and apparatuses for managing the presentation of information are described herein, with reference to examples and exemplary embodiments. Specific terminology is employed in describing examples and exemplary embodiments. However, the disclosure of this patent specification is not intended to be limited to the specific terminology so selected and it is to be understood that each specific element includes all technical equivalents that operate in a similar manner.

For example, the term “client computer system” or “client” as used in this application generally refers to a mobile device (cell phone, smartphone, tablet computer, ebook reader, etc.), computer (laptop, desktop, gaming console, etc.), television display (plasma, LCD, CRT, OLED, etc.) etc. including future technologies or applications enabling the same or similar results having sufficient input, storage, processing and output capabilities to execute one or more instructions as will be described in detail herein and as will be appreciated to those skilled in the relevant arts.

As another example, the term “server” generally refers to any one or more network connected devices configured to receive and transmit information such as audio/visual content to and from a client computer system and having sufficient input, storage, processing and output capabilities to execute one or more instructions as will be described in detail herein and as will be appreciated to those skilled in the relevant arts. For example, a “cloud server” may be provided which may not actually be a single server but may be a collection of one or more servers acting together as a shared collection of storage and processing resources. Such collection of servers need not all be situated in the same geographic location and may advantageously be spread out across a large geographic area.

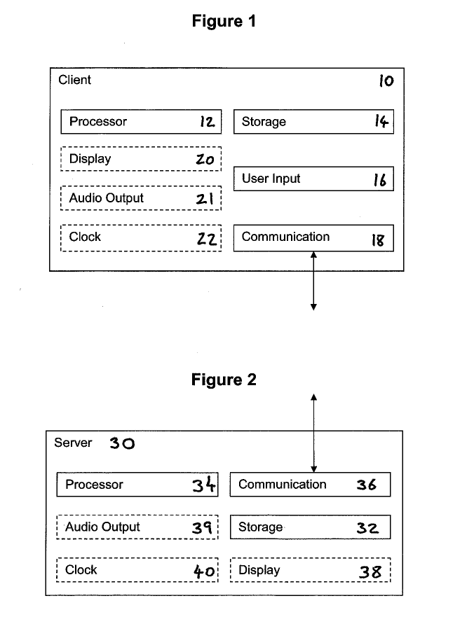

Examples of a client computer system and a server are shown in FIGS. 1 and 2, respectively. A client computer system 10 may include a processor 12, storage 14, a user input part 16, a communication transceiver 18, and optionally a display 20, audio output 21 and clock 22. A server 30 may include storage 32, a processor 34, and a communication transceiver 36. A server 30 may also optionally include a display 38, audio output 39 and/or clock 40.

The term “storage” as used in this application generally refers to any (one or more of) apparatus, device, composition, and the like, capable of retaining information and/or program instructions for future use, copying, playback, execution and the like. Some examples of storage include solid state storage devices, platter-type hard drives, virtual storage media and optical storage media formats such as CDs, DVDs and BDs, etc.

Examples of user input parts include physical buttons which may be displaced by some distance to register an input and touch-type inputs which register user input without noticeable displacement, for example capacitive or resistive sensors or buttons, a touch screen, etc. A user input part may also include, for example, a microphone and voice translation processor or program configured to receive voice commands, acceleration sensors to receive movement or gesture commands such as horizontal or vertical waving or tipping motions, etc. A user input part may also take the form of, for example, a keyboard, mouse, stylus, etc.

A communication transceiver may be a wired or wireless data communication transceiver, configured to transmit and/or receive data (which may include, for example, audio, video or other information) to and/or from a remote server or other electronic device. As an example, a wireless data communication transceiver may be configured to communicate data according to one or more data communication protocols, such as GSM (Global System for Mobile Communications), GPRS (General Packet Radio Service), CDMA (Code Division Multiple Access), EV-DO (Evolution-Data Optimized), EDGE (Enhanced Data Rates for GSM Evolution), 3GSM, HSPA (High Speed Packet Access), HSPA+, LTE (Long Term Evolution), LGE Advanced, DECT, WiFi™, Bluetooth™, etc. As one example, a wireless data communication transceiver may be configured to communicate data using an appropriate cellular telephone protocol to and/or from a remote internet server, for example, to communicate text, audio/visual and or other information to and/or from the client. As another example, a wired data communication transceiver may be configured to transmit and/or receive data over a LAN (Local Area Network) via a wired Ethernet connection and/or over a WAN (Wide Area Network) via a wired DSL (Digital Subscriber Line) or an optical fiber network.

A client or server may include one or more displays capable of displaying text or graphics. Examples of types of displays possibly comprised in a client or server include e-ink screens, LCD (Liquid Crystal Display), TFT (Thin Film Transistor), TFD (Thin Film Diode), OLED (Organic Light-Emitting Diode), AMOLED (Active-matrix organic light-emitting diode) displays, etc. Displays may also include additional functionality such as touch sensitivity and may comprise or at least may communicate with the user input part. For example, the display of the client may include capacitive, resistive or some other type of touch screen technology. Generally, such touch screen technology is capable of sensing the position and sometimes even the force with which a user may touch the screen with one or more of their fingers or compatible implements.

A client or server may also include one or more audio outputs capable of outputting sound which may be heard by a user or audio data or signals to another device capable of outputting sound which may be heard by a user. Examples of audio outputs include a headphone jack, one or more speakers, a wireless connection (Bluetooth, for example) to a complementary wireless audio output appliance, headphones, etc. A client or server may optionally include an audio output but not a display.

In an aspect of the present application, a client or server may execute instructions tangibly embodied in storage, using a processor, to manage the presentation of information. Such instructions are generally collectively referred to herein as a “program” for convenience and brevity.

In an aspect of the present application, an incoming information flow may be itemized, either by its nature (such as in the case of emails, for example) or by operation of a program (such as updates to a breaking news website which are detected and separated by a monitoring program).

A flow of information may be received by a client or server from a plurality or sources or from a single source. For example, a client may be configured to receive emails from one or more email handling servers, Facebook messages from a Facebook message handling server, weather forecasts from a weather forecast website, photographs from a cloud storage server, calendar items from a calendar program operated by the client or a server, voicemails from a local or remote recording apparatus, blog updates received from a subscribed RSS (Really Simple Syndication) feed, etc.

Items of information may take many forms, some of which are described above. Other examples include, without limitation, Twitter messages, other social media messages or activity notifications, news stories, documents, songs, SMS (Short Message Service) messages, BBM (BlackBerry Messenger) messages, etc.

In another example, items of information may be generated from a source of information. For example, an item may be generated based on the stock price of a particular stock at a given time, based on activity or status of a home automation system, etc. or may be based on user-defined triggers. Examples of user defined triggers include, for example, if the temperature outside climbs above 70° F., if a picture of the user on Facebook receives more than 5 “likes,” if traffic on the user's usual route home from work is forecast to cause a delay of more than 10 minutes, if a website is updated with new information, etc.

In one example, information flows and/or items may be stored in local storage of a client or server upon receipt or generation. For example, an email message received from an external email source may be cached locally by a server performing a program according to the present application. A client in communication with the server may be provided with the email message immediately upon its receipt by the server or later, upon requesting the message from the server or upon the server sending the message to the client as a part of a periodic update routine.

In another example, information flows and/or items may not be stored in local storage of a client or server, or may be partially stored in local storage of a client or server. A pointer or other identification may be stored in local storage of a client or server in place of an information flow or item directing a client or server to the location at which an information flow or item is stored.

Regardless of the source or nature of an item, each item received by a client or server may be indexed. That is, each received item may be assigned a timestamp in connection with an identification of the item. The timestamp and associated item identification may be stored as an index entry in an index. As shown in FIG. 8, an index 86 may include an index entry 88 for each item which includes an identification of the item 90 and an associated timestamp 92. Index entries may also store other information related to the item. An index storing index entries relative to items received by a client may be stored in a storage of the client, a storage of a server in communication with the client or both.

A timestamp may be initially assigned to an item based on a timestamp assignment rule. For example, the timestamp initially assigned to received emails may be configured as the time the email was sent by the sender, received by the client or server, etc. As another example, an initial timestamp may be assigned to an item based on when the item was received by a second client or a second server in communication with a first client or a first server which first received the item. For example, a picture received by the client though a USB connection with a digital camera may be assigned an initial timestamp corresponding to the time the picture was received by the client as determined by a clock of the client. Alternatively, the picture may be assigned an initial timestamp based on a time at which the digital camera or metadata associated with the picture indicates the picture was taken by the digital camera. Initial timestamps may also be assigned by a third party. For example, a blog website may record as a part of an RSS stream a time at which a particular blog entry was published. This publication date may be assigned as the initial timestamp in the index for the index entry associated with an item corresponding to the blog entry.

An index entry may also store other information relative to items such as, for example, metadata related to the item (for example a sender address associated with an email, an identification of the item's source or other attributes, a song's composer, performer or album name, a file type or a file size, etc.), and any permissions associated with the item (such as, for example, private, public, visible, read only, etc.). In another example, an index entry may also contain the full or partial text of an item containing text in any part of its data or metadata.

Items (which may be stored separately from the index or index entries) may be stored locally in a storage of the client or server which received them or may be stored in a storage of a client or server with which the receiving client or server is in communication.

Items may be configured in (or a corresponding graphical representation may be configured in) graphical form for display on a display. Some items may be received in graphical form (such as, for example, an email or news article) while a graphical representation may be generated for other received items. For example, an associated graphical representation may be generated for a received digital audio file of song recording.

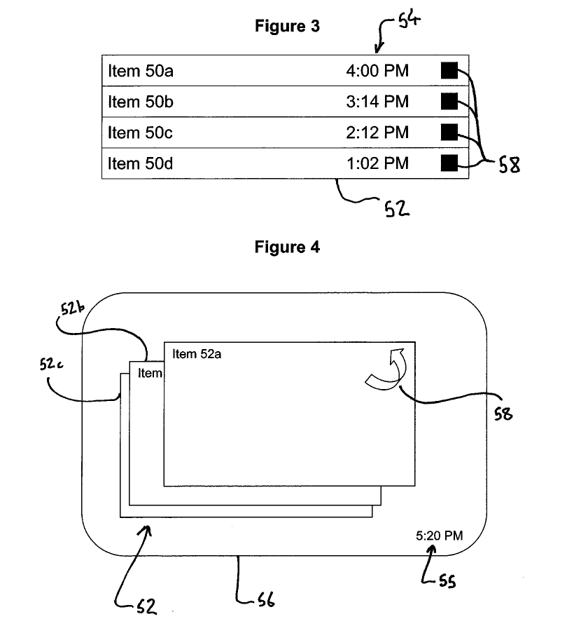

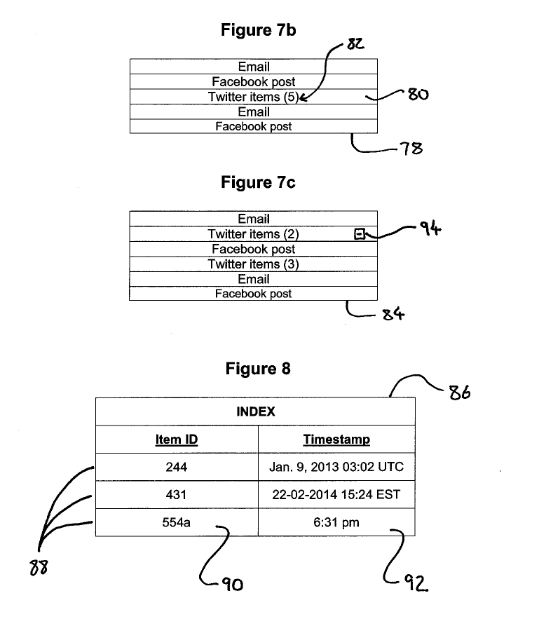

In one aspect of the present application, items may be graphically displayed in a time-ordered arrangement according to timestamps associated therewith. For example, as shown in FIG. 3, items 50a, 50b, 50c and 50d are displayed in a time-ordered list or queue 52 according to their associated timestamps 54. It should be noted that while the timestamps 54 are visibly displayed in the example shown in FIG. 3, the timestamps 54 may not be visually displayed in other implementations according to the present application, as shown, for example, in FIG. 7a.

In the example shown in FIG. 3, each item is visible regardless of its position in the list 52. However, in another example, shown in FIG. 4, items 52b and 52c other than a “current” item 52a may be partially or completely blocked from view or may not be displayed at all. A “current” item may also be partially blocked from view. Also shown in FIG. 4, a visible clock 55 may be shown on a display screen 56 which corresponds to a clock of the client or server to display a current time.

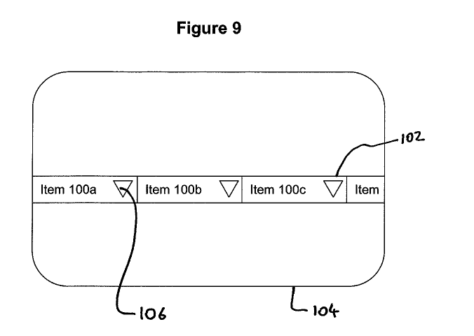

In another example, shown in FIG. 9, items 100a, 100b and 100c are graphically displayed in a horizontally aligned list 102 (i.e. a “ticker”), similarly to the way items 50a-50d are shown displayed in a vertically aligned list 52 in FIG. 3. Throughout the present application, it will be understood that aspects described relative to lists and queues may be equally applicable to vertically or horizontally (or any other directionally) aligned lists or queues. Items may be ordered in the list 102 according to their associated timestamps. The list 102 may be configured to scroll across a display screen 104 automatically or in response to user input. An automatic or manual scrolling speed may be configured according to a volume of items or a receipt rate of incoming items, for example. In another example, scrolling of a list may be halted by the user hovering a cursor over the list.

Lists may be configured homogeneously, displaying only items of a particular type (for example, only emails), from a particular source (for example, only from a Facebook server), having a timestamp within a particular time range, etc. In addition, lists may be configured to display only items meeting two or more such requirements (i.e. the result of a logical AND argument). Alternatively, lists may be configured to display a heterogeneous arrangement of items, either as a list of all items or as a list of two or more different categories of items (i.e. the result of a logical OR argument).

Accordingly, a graphical interface may be configured to display a historical record of items. Generally, received items are initially assigned timestamps in the present or in the past. Thus, as soon as an item is displayed based on its initial timestamp, its timestamp may already be in the past relative to a current time. Examples of conventional displays of this nature include conventional email inbox displays.

In another aspect of the present application, items may be presented to a user in other than graphical form. For example, items may be presented aurally to a user. In this example, textual items may be processed by a text-to-speech processor and read aloud (via speakers, headphones, etc.). Audio items may simply be played. The timing of the non-graphical presentation of such items may be configured according to the timestamps of the items in a queue. For example, items may be processed by a text-to-speech processor and aurally output through a user's headphones in an order according to the items' respective timestamps.

In an aspect of the present application, timestamps associated with items may be reassigned. In one example, a timestamp reassignment command may be received from a user as a result of the user operating a user input part. For example, a user may click a timestamp reassignment “button” 58 or 106 displayed in connection with an item using an appropriate pointer input such as a mouse, stylus or touch sensitive display screen. In another example, a user may issue a voice command.

A timestamp reassignment command may be configured to cause a reassignment of the timestamp associated with an item to a time which is before or after the initial or current timestamp associated with the item. A timestamp reassignment command may reassign the timestamp associated with an item to a time in the past, a time in the future or the present time.

In one example, a timestamp reassignment command may be relative to the current time stamp (i.e. “set to five minutes after current timestamp” or “set to one week ahead” or “set to tomorrow morning”). In another example, a timestamp reassignment command may be absolute (i.e. “set to 5:00 pm”).

In yet another example, a timestamp reassignment command may be based on something other than a relative or absolute time. For example, a timestamp reassignment command may be based on a weather or meteorologic phenomena (i.e. “set to sundown” or “set to when it last rained”), a signal received from a GPS (Global Positioning System) receiver (i.e. “set to when a current location is within zip code 10001”), a signal received from an altimeter (i.e. “set to when a current elevation is greater than 5,000 feet”), a status of the client or server (i.e. “set to tomorrow morning five minutes after the client is first initialized for the day”), etc.

A timestamp reassignment command may also rely on the result of a more complex determination. For example, a timestamp reassignment command may be configured to set the timestamp of an item to “when I am at the office.” In this example, the processor of a user's client may be configured to determine, based on the number of emails received from a work address, a usual working time window for the user and compare that time window to a recorded signal from a GPS receiver to determine a working location where the user is located most often during the working time window. Thus, the result of the “when I am at the office” timestamp reassignment command could be a trigger configured to assign the current time to the timestamp of the associated item as soon as the GPS receiver determines that the client is at the working location.

Timestamp reassignment commands which set a trigger for the reassignment of a timestamp, such as the above “when I am at the office” command or a “when it is raining” command, may be configured to assign a null timestamp to the associated item in the meantime before the trigger is satisfied. Accordingly, an item associated with a null timestamp may drop out of a displayed item queue. In another example, an item with a null timestamp may be removed from a first queue and placed in an “awaiting trigger” queue. Alternatively, a timestamp reassignment command which sets a trigger for the reassignment of a timestamp may only reassign the timestamp after satisfaction of the trigger, leaving the existing timestamp in place until such time as the trigger is satisfied.

Another example of a complex timestamp reassignment command includes, for example, “when I have time.” In this example, a processor could be configured to analyze, based on an amount and/or complexity of text or other information included in the item associated with the command, when a suitably large time window exists between other items' future timestamps (also taking into account the size and/or complexity of those items). Alternatively, a “when I have time” timestamp reassignment command may be configured to find a predetermined period of open time in which to reassign a timestamp. For example, a “when I have time” timestamp reassignment command may be configured to find the next 10 minute opening between existing timestamps into which to reassign the item for which the timestamp reassignment command was received.

In addition, the present application may be configured to “learn” patterns, such as the example of the “when I am at the office” timestamp reassignment command. Patterns may be based on time, location, temperature, day of the week, or any other piece of information. Corresponding timestamp reassignment commands may be manually or automatically configured. Examples of such commands include the above “when I am at the office” command, a “when I am on the train home” command (requiring learning of both time and location information associated with an evening train commute), a “when I wake up” command (requiring learning of time information based on, for example, signals received from home automation motion detectors), etc.

Users may also be provided with the ability to pre-set various variables. For example, a user may be provided with the ability to pre-set a geographic location corresponding to “home” or “office.”

In another aspect, a timestamp reassignment command may include a recurring component. For example, a timestamp reassignment command may indicate that the timestamp associated with an item should be reassigned to ten minutes in the future and should be reassigned every 5 minutes in the future thereafter until read or acted upon by the user or the recurring component of the command is disabled. In this example an initial time stamp would be set from, for example, 2:10 pm to 2:20 pm, then to 2:25 pm, then 2:30 pm, and then left at 2:30 pm after the user reads the associated item at 2:33 pm. In another example, an item's timestamp may be configured to permanently recur, such as in the example of a regularly scheduled weekly meeting entry in the user's calendar.

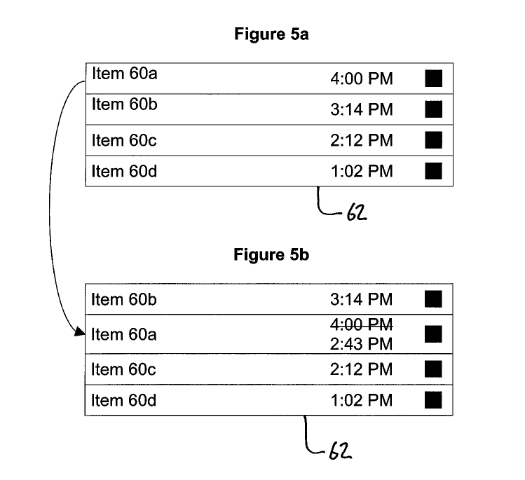

In yet another aspect, a timestamp reassignment command may be sent by a user dragging a displayed item out of its currently displayed order using an appropriate input device. For example, as shown in FIGS. 5a and 5b, a user may drag item 60a from the top of list 62 to place item 60a between items 60b and 60c. In doing so, a timestamp reassignment command may be generated which has the effect of reassigning the timestamp of item 60a to a time between items 60b and 60c.

In still another aspect, multiple items having been assigned or reassigned the same timestamp may be automatically distinguished from one another by incrementing the conflicting timestamps so as to reassign them a time (for example, milliseconds, minutes, etc.) apart. The order in which the conflicting timestamps is reassigned may be determined at random or according to one or more predefined criteria. For example, items with timestamps having been assigned oldest (i.e. having an older “time of assignment” which time may be different than a timestamp's recorded time value) may be given time priority during automatic timestamp reassignment due to time conflicts.

In another aspect, a timestamp associated with an item may be automatically reassigned based on one or more predetermined criteria. For example, a rule may be established whereby SMS text messages which have not been read and have an associated timestamp older than three hours automatically have their timestamp reassigned to the present time.

Upon reassignment of a timestamp, displayed items may be automatically or manually resorted based on the reassigned timestamps.

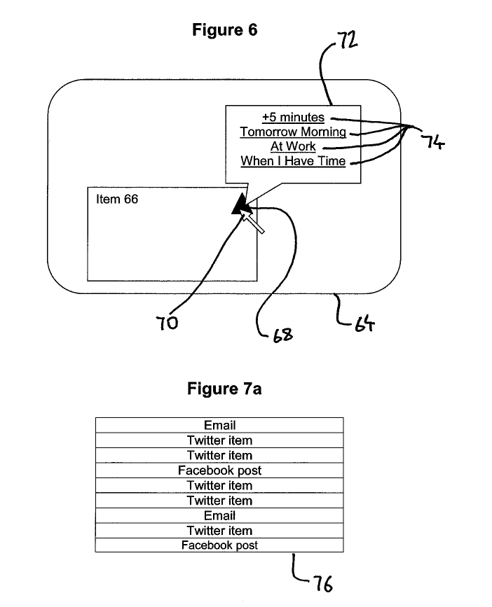

FIG. 6 shows an example of a display 64 showing item 66 which includes a timestamp reassignment command button 68. Hovering over or clicking the timestamp reassignment command button 68 with a cursor 70 may be configured to cause an expanded timestamp reassignment command window 72 to be displayed. The expanded timestamp reassignment command window 72 may be configured to display command inputs 74 for one or more different timestamp reassignment commands, operable by a user clicking one of the displayed command inputs 74.

According to another aspect of the present application, an item of information may include dynamic content which is not static or fixed. For example, an item may include a current stock price of a given stock. This item may be configured with a recurring timestamp reassignment command configured to both reassign the timestamp of the dynamic item and also update the item's stock price information at a predetermined time interval.

As another example, a dynamic item of information may be defined which corresponds to a website's home page. This dynamic item may be configured with a recurring timestamp reassignment command configured to both reassign the timestamp of the dynamic item and update the content of the website home page stored as the item at a predetermined time interval.

In a further example, a dynamic item may be configured with a recurring timestamp reassignment command configured to update the content of the dynamic item at a predetermined time interval and only reassign the timestamp associated with the item if the content changed since the last update or since the item was last viewed. In this way older dynamic content which has not been recently updated may be prevented from clogging a user's item queue.

In another aspect, items may be automatically created or generated according to predetermined item generation parameters. For example, a user's internet browsing history may be monitored and items may be generated corresponding to frequently visited websites. As an example, websites which the user visits for at least a predetermined amount of time per day or websites which the user visits at least a predetermined number of times per week may be selected for item generation. An automatically generated item may be configured with a recurring timestamp reassignment command matching the user's typical activity concerning the source of the automatically generated item. For example, if a user typically visits a particular website at 9:00 am and 6:00 pm each weekday, an associated item may be generated and configured with a recurring timestamp reassignment command configured to reassign the timestamp of the generated item and also update the content of the item each weekday at 8:30 am and 5:30 pm. Accordingly, a user which would otherwise check the content of various websites throughout the day by navigating an internet browser to those separate websites may be provided with the ability to simply glance at their automatically updated item queue whenever they have time.

In another example, websites may be selected for automatic item generation based on other factors. For example, a user's email or social media may be monitored and inspected for embedded links or URLs (Uniform Resource Locators). Items may be automatically generated based on webpages associated with those embedded links or URLs, automatically retrieving information from the associated webpages for inclusion as the items' content and inserting the items into the queue. Items associated with webpages or subsections of webpages or other dynamic items may also be manually selected by the user to serve as the basis for a generated item.

In another aspect, items associated with webpages may be configured as active internet browser items. Active internet browser items may configured with all or much of the functionality of a conventional internet browser parsing and displaying a webpage. In an active internet browser item, webpage code may be processed and the result may be displayed in real time within the item's display, so that such an active internet browser item is up to date when the user looks at it, and contains the same information the user would see were he to visit the associated webpage in a traditional internet browser.

In another aspect of the present application, items may be visually clustered in (or removed from) the display based on any combination of one or more clustering criteria. Clustering criteria may include any item-related information, for example, an item's source (email, Facebook, Twitter, etc.), a type of item (text, picture, song, etc.), name of sender, time received, timestamp, etc.

Examples of clustering are shown in FIGS. 7a-7c. FIG. 7a shows an unclustered item queue 76. FIG. 7b shows an item queue 78 to which a clustering filter has been applied to cluster all five Twitter items into a single clustered queue entry 80. A clustered queue entry 80 may be ordered relative to other items in the queue based on properties of the clustered items. For example, clustered queue item 80 may be assigned a timestamp according to the previous aspects which corresponds to an average, earliest or latest timestamp of the clustered entries. As shown, the clustered queue entry 80 may also be configured with a cluster size indication 82 to indicate a number of items condensed into the clustered queue entry 80.

FIG. 7c shows an example of partial clustering. As shown, the Twitter items in the queue 84 are partially clustered. Partial clustering may be based on any combination of one or more previously described clustering criteria, but also based on one or more cluster division criteria. Cluster division criteria may include, for example, a maximum number of clustered items allowed within a cluster, a maximum time window into which timestamps or other time information associated with the clustered items must fit, a rule that only items which match the clustering criteria and are adjacent in the queue may be clustered together, etc. As one example, all Twitter items may be clustered, but separate clustered queue entries are generated for Twitter entries having a sent time on separate days (i.e. a separate clustered queue entry is generated for Monday's Tweets, Tuesday's Tweets, etc.).

Clustering may be configured to be implemented automatically or manually. As an example of automatic clustering, a processor or a client or server may be configured to determine a relative importance of an item (by, for example, parsing text of an item, determining a type of item, etc.) and clustering only enough lower importance items so as to free up enough display area to be able to display all higher importance items together with clustered queue entries in a queue.

As another example of automatic clustering, a processor of a client or server may be configured to cluster items received from sources based on a rate at which items from that source are arriving and cluster only items from those sources having higher arrival rates.

In another example, a processor may be configured to cluster a predetermined number of items meeting a clustering criterion. For example, a processor may be configured to generate a clustered queue entry for every five emails received or every three Facebook alerts received.

Clustering may be configured differently based on other input information. For example, clustering criteria or cluster division criteria may be different depending on a time of day or a location sensed by a GPS receiver.

The extent to which clustering is applied may be an incremental or continuous scale. Such scale may be automatically adjusted or may be manually adjusted by a user. For example, if clustering processing is being applied so that a items of a certain data type are being clustered by time, i.e. a clustered queue entry represents all items of that data type received during a period of X minutes, that number X may be adjustable incrementally or continuously, automatically or via a dial, sliding scale or other similar control, thereby allowing precise control over the extent to which clustering takes place (the “aggressiveness” of the clustering processing). Such a cluster control may similarly adjust the number of items per clustered queue entry, or the types of items which are clustered as opposed to inserted into the queue individually.

In another example, a plurality of clustering controls may be provided and configured to separately control clustering processing applied to different groups items. The groups of items may be configured broadly. For example, clustering controls may be separately provided according to items' sources (i.e. three separate clustering controls may be provided for emails, Twitter posts and items originating from Facebook), according to item data type, according a sender of an item, according to a time of day or location at which items are received (i.e separate clustering controls for “office” and “home” and/or “morning” and “evening”), etc.

Clustering processing may also take account of the likely importance or relevance of an item to the user, even within a particular data type. For example, items from a user's Facebook news feed may be clustered whereas direct messages sent to the user via Facebook are displayed in the queue individually to draw attention to their likely higher importance.

A clustered queue entry may be labeled according to the clustering criteria and/or cluster division criteria associated with the generation of that clustered queue entry or may be labeled according to some other information, including information which may be derived from the clustered items. In another example, “thumbnails” of clustered items may be displayed in the clustered queue entry. As a further example, a clustered queue entry label may periodically cycle through thumbnails or other information relative to the various underlying clustered items.

Incoming items may be clustered and displayed on a slightly delayed basis. For example, a buffer time may be established during which clustering processing is allowed to take place for newly received items. In other words, during a buffer time, an item may not be displayed in a queue while clustering processing determines whether or not the item is to be clustered. At the end of the buffer time, a new item may be included in a clustered queue entry or may be displayed as a stand-alone item when it first appears in a queue based on the determination of the clustering processing. Such a configuration may provide a smoother graphical interface experience for a user with rapidly arriving items and/or complicated clustering configurations. As another example, a buffer may be based on number of items received instead of time. For example, a 100-item buffer may be implemented in which case the 100 newest items may not by displayed while clustering processing is applied to those items.

Alternatively, clustering processing may be applied in real time, and the display of a queue may be updated accordingly as items are clustered based on clustering processing continuously applied to incoming items.

As yet another example, a clustering buffer may only be applied to certain items meeting a buffering criteria, leaving items which do not meet the buffering criteria to be displayed in real time. In this example, only items buffered may be subjected to clustering processing or clustering processing may be applied to both buffered items and non-buffered items. Of course, it will also be apparent that an inverse do-not-buffer criteria may be applied in which case items meeting the do-not-buffer criteria are displayed in real time while other items are buffered. In one example, items of lower importance (a buffering criteria) are buffered and clustered while in the buffer, while items having higher importance are displayed in a queue in real time.

The display may be configured to accept a decluster command in the form of a user clicking on a clustered queue entry, clicking on a graphically displayed decluster command input button (for example button 94, shown in FIG. 7c) or similar user interaction. Other examples of decluster command inputs may include, for example, a user hovering over a clustered queue entry for a predetermined period of time, a keystroke entered on a keyboard, etc. In response to a decluster command, a separate cluster queue may be displayed containing the items of the cluster, the clustered items may be resorted into position in the original queue according to their individual timestamps, or the clustered items may be displayed in a sub-queue within the main queue.

In addition, the embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted for each other within the scope of this disclosure.

What is claimed is:

1. An apparatus for managing the presentation of information, comprising:
a processor;
a communication transceiver configured to receive a plurality of items;
a display;
a user input configured to receive a timestamp reassignment command; and
storage storing instructions performable by the processor to:
generate, for each received item, an index entry in an index including an identification of the item and an initial timestamp associated with the identification of the item;
cause the display to display a plurality of received items in graphical form and ordered according to timestamps in the index which are associated with identifications of the items; and
reassign, in response to a receipt of a timestamp reassignment command associated with a particular item, a timestamp associated with an identification of the particular item in the index to a reassigned timestamp according to the timestamp reassignment command.

2. The apparatus of claim 1, wherein the index is stored by the storage.

3. The apparatus of claim 1, wherein the initial timestamp is determined according to attributes of the associated item.

4. The apparatus of claim 1, wherein a timestamp reassignment command is configured to cause the processor to determine the reassigned timestamp based on timestamps associated with identifications of other items in the index.

5. The apparatus of claim 4, wherein the timestamp reassignment command is configured to cause the processor to select a reassigned timestamp that is between timestamps associated with identifications of other items in the index.

6. The apparatus of claim 1, wherein the timestamp reassignment command is configured to cause the processor to increment the timestamp associated with the identification of the particular item in the index by an amount of time specified in the timestamp reassignment command to obtain the reassigned timestamp.

7. The apparatus of claim 1, wherein the timestamp reassignment command includes at least one reassignment criteria and the timestamp reassignment command is configured to cause the processor to analyze information unrelated to the particular item for satisfaction of the reassignment criteria to determine the reassigned timestamp.

8. The apparatus of claim 7, wherein the information unrelated to the particular item includes at least one of a geographical location identified by GPS receiver in communication with the apparatus, a weather forecast and a current time.

9. The apparatus of claim 1, wherein the timestamp reassignment command includes at least one reassignment criteria and the processor is configured to assign a null timestamp to the particular item and cause the display to cease displaying the particular item in graphical form until the processor determines that the reassignment criteria have been met.

10. The apparatus of claim 1, wherein the timestamp reassignment command is a recurring timestamp reassignment command and is configured to cause the processor to reassign the timestamp of the particular item a plurality of times in according to a parameters specified by the recurring timestamp reassignment command.

11. The apparatus of claim 10, wherein the recurring timestamp reassignment command is configured to cause the processor to check for updates to content associated with the particular item each time the timestamp is reassigned in accordance therewith.

12. A method for managing the presentation of information, comprising the steps of:
receiving a plurality of items;
generating, for each received item, an index entry in an index including an identification of the item and an initial timestamp associated with the identification of the item;
displaying a plurality of received items in graphical form ordered according to timestamps in the index which are associated with identifications of the items;
receiving a timestamp reassignment command associated with a particular item; and
reassigning, in response to receipt of the timestamp reassignment command associated with the particular item, a timestamp associated with an identification of the particular item in the index to a reassigned timestamp according to the timestamp reassignment command.

13. An apparatus for managing the presentation of information, comprising:
a processor;
a communication transceiver configured to receive items;
a display; and
storage storing instructions performable by the processor to:
cause the display to display a queue of information based on the received items;
perform clustering processing to group selected items from the plurality of received items into a clustered queue entry based on clustering criteria; and
cause the display to display the clustered queue entry in graphical form as an entry in the queue of information.

14. An apparatus according to claim 13, wherein the instructions are also performable by the processor to cause the display to display a selected item which is not grouped by the clustering processing in graphical form as an entry in the queue of information.

15. An apparatus according to claim 13, wherein the clustering criteria includes a source from which items are received.

16. An apparatus according to claim 13, wherein the clustering processing is also performed by the processor based on cluster division criteria such that groups of items determined based on the clustering criteria are divided into subgroups based on the cluster division criteria and the subgroups are the basis for the clustered queue entries.

17. The apparatus according to claim 13, further comprising a user input configured to receive a clustering aggressiveness command, wherein the extent of the clustering processing is controlled according to the received clustering aggressiveness command.

17. The apparatus according to claim 13, wherein the clustering processing is applied to each received item according to attributes of each received item such that clustering processing applied to one received item is different than clustering processing applied to another received item based on differences in attributes of the one received item and the another received item.

18. A method for managing the presentation of information, comprising the steps of:
receiving a plurality of items;
displaying a queue of information based on the received items;
performing clustering processing to group selected items from the plurality of received items into a clustered queue entry based on clustering criteria; and
displaying the clustered queue entry in graphical form as an entry in the queue of information.

19. The method of claim 18, further comprising:
displaying a selected item which is not grouped by the clustering processing in graphical form as an entry in the queue of information.

20. An apparatus for managing the presentation of information, comprising:
a processor;
a communication transceiver configured to receive a plurality of items;
an audio output;
a user input configured to receive a timestamp reassignment command; and
storage storing instructions performable by the processor to:
generate, for each received item, an index entry in an index including an identification of the item and an initial timestamp associated with the identification of the item;
cause the audio output to sequentially output audio corresponding to a plurality of received items, the audio ordered sequentially according to timestamps in the index which are associated with identifications of the items; and
reassign, in response to a receipt of a timestamp reassignment command associated with a particular item, a timestamp associated with an identification of the particular item in the index to a reassigned timestamp according to the timestamp reassignment command.
